(19) United States
(12) Patent Application Publication
(10) Pub. No.: US 2014/0279204 A1
(43) Pub. Date: Sep. 18, 2014

(54) RECURRING TRANSACTIONS FOR PURCHASES

(71) Applicant: GIMMEANOTHER LLC, Chicago, IL (US)

(72) Inventors: Jon D. Roketenetz, Chicago, IL (US); Andrew J. Sannes, Lake Forest, IL (US); Andrew P. Figgins, Chicago, IL (US); Mark D. Erickson, San Francisco, CA (US)

(73) Assignee: GIMMEANOTHER LLC, Chicago, IL (US)

(21) Appl. No.: 14/208,677

(22) Filed: Mar. 13, 2014

Related U.S. Application Data
(60) Provisional application No. 61/787,806, filed on Mar. 15, 2013.

(51) Int. Cl. G06Q 30/06

(52) U.S. Cl. CPC G06Q 30/0631
USPC 705/26.7

(57) ABSTRACT

The invention provides a method for identifying recurring products and/or transactions. A record of purchases of a user is reviewed, and the record includes purchases from one or more retailers. The record is stored in a temporary or activated account for the user. A recurring pattern of the purchases from the stored record is identified. A recommendation to initiate a transaction based on the identified recurring pattern is provided. The method further receives a confirmation to the provided recommendation. Further facilitates a future easier purchase based on recurring pattern.

### CROSS-REFERENCE OF RELATED APPLICATIONS

This is a nonprovisional patent application of provisional application serial no. 61/787,806, filed on Mar. 15, 2013, in which the disclosure thereof is incorporated by reference in its entirety.

### BACKGROUND

Shopping activities and behaviors have always been interesting phenomena over which merchants wish to have a firm control. Merchants always want to capture and retain loyal and repeat customers, in addition to attracting new ones. Moreover, merchants also love to maintain those consumers who are, indeed, already familiar with the products that merchants sell on a frequent basis. With the convenience of mobile phones and devices, the mobile app environment has taken mobile users' online shopping patterns to a new height. Shoppers can now search and shop online so frequently and easily, yet some of the merchants have neglected to create convenience to their loyal and repeat customers in the mobile space.

There is an enormous amount of effort to quicken the shopping experience via technology like Asynchronous JavaScript (AJAX) and XML, mobile, thoughtful design, and in-browser media. Other techniques have also been employed, such as new approaches to page layout and search results, shopping cart design, etc. These efforts have largely focused on shopping for first time items, primarily on a standalone desktop or laptop. Currently, there is a lack of emphasis on or effort to create an easy and effective shopping experience for repeated or recurring products.

Although everyone who shops online has a set of products to potentially purchase again in the future, there appears to be a lack of effort or care to facilitate users or consumers to process recurring orders or transactions. Existing technologies rely on subscription-based techniques to facilitate the transactions. For example, a merchant may place the users' or consumers' contact information, such as an email address or the last shipping address on a contact list. Based on an arbitrary interval, the merchant may send out a reminder email to the users or consumers seeking potential reorders. If a user wishes to return to re-purchase the item, the user would proceed with a regular purchasing workflow in the following fashion, but not always in such order and may include other required actions: find the item; place the item in a shopping cart; log-in to the shopping account (if not already logged-in); confirm payment and shipping; and place the order.

Unfortunately, these techniques fail to address and focus on the recurring nature of the products and the purchasing experience. Currently, there are no convenient solutions to address the intricacy of timing, in particular, for products that expire frequently but not at set intervals. Many existing solutions for recurring orders have tried to time a delivery for a product that does not expire or finish its useful life in set intervals rather than offering a consumer an option to quickly request additional product(s).

Other techniques include saving previous orders for the users or consumers and allowing the users or consumers to place the same order (and not necessarily at an individual product level) by recalling the previous identical order in full.

Other online merchants have tried, but failed to create a user-friendly experience for recurring orders as well. Typically, online merchants merely use an existing shopping model and platform and add a “reorder” or “re-order” option (hereinafter the terms reorder and re-order have the same meaning and may be used interchangeably). However, this option repeats the cumbersome ordering process even though it is clear that the user or customer knows exactly what he or she wants and is familiar in some regard with the retailer or merchant (hereinafter, the terms retailer and merchant have the same meaning and are used interchangeably). In addition, as merchants try to drive orders that misalign with the timing of consumers' expected reorders, retailers may opt to incentivize the sale by discounting or greater email frequency communication, which lowers company margins or disenchants the consumers, respectively. This may result in decreased net profits for the merchant and ill-timed and/or irrelevant communication to the consumer.

An additional technique includes providing a wish list type functionality for customers to save their products; however, these types of functions merely allow customers to save products. These functions do not effectively minimize order time or the need to directly engage the given brand's website or existing checkout process to complete an order. Merchants have also created subscription type models aimed at sending their customers their products on a recurring timed set interval basis. This results in customers receiving goods either too early or too late, and does not allow consumers to purchase their favorite products at their convenience. At the same time, the users or consumers may not want to go through the same shopping workflow for recurring products.

Most cart systems are built on different or proprietary technologies, and they are not designed to interact or communicate with other cart systems or payment workflows. This leaves the consumer at a disadvantage, unable to batch products from across their favorite stores. The consumer needs to complete multiple checkout routines, remember multiple passwords, and trust their credit information with multiple retailers.

### SUMMARY

Aspects of the invention enable users or consumers to easily and quickly place orders for recurring products without dealing with the hassles of shortcomings of other technology. Embodiments of the invention employ a third-party “remote control”—in a form of a mobile app—along with a third-party depository data storage or database to consolidate products ordered from multiple stores into one storefront. Further embodiments of the invention implement a mobile storefront across different mobile platforms such that users or consumers can finalize a recurring transaction within seconds. For purposes of this nonprovisional patent application, “recurring transaction” means a transaction or series of transactions that can be considered to be a potential transaction or series of transaction occurring more than once.

According to one embodiment, a method for identifying recurring transactions includes reviewing a record of purchases of a user. The record includes purchases from one or more retailers. The reviewed record is stored in an account for the user. A recurring pattern of the purchases from the stored record is identified based on any one or more factors, which include, without limitation or combination of factors: type; nature of product; package quantity; order quantity; volume of package or material; weather or temperature of a location of the user; a geography or location of the user; durability of a product; a recommended daily dosage; nutritional or caloric content of product; season or time of the year; industry recommended obsolescence time; warranty coverage; time of day; holiday schedule; category trends; usage patterns; frequency of orders; date; product category; and/or accepted product lifespan. A recommendation to initiate a recurring transaction based on the identified recurring pattern is provided. The method further provides a confirmation for the given recommendation.

Another embodiment of the invention includes a system for facilitating recurring transactions via a first database at a first site for storing product, order, and customer information. The system also includes a computer network connection. A processor is disposed at a second site, and the first site being different from the second site. The processor is configured to execute computer-executable instructions for generating a set of recurring products from the first database. The processor is also configured to establish an account of recurring transactions in response to a request received through said computer network connection. The account of recurring transactions identifies one or more recurring products from the set of recurring products from the first database. The first database stores information associated with the account. The processor also provides one or more recurring transactions in a list based on the identified one or more recurring products in the account. The processor further, upon receiving a transaction request via the computer network connection, facilitates a completion of a recurring transaction from the provided list of recurring transactions.

Additionally, a further embodiment of the invention provides a method for processing recurring transactions that includes one or more retailers from a list of potential transactions. Ordering information from the one or more identified retailers is collected. A recurring frequency is identified based on any one or more factors of a transaction, which include, without limitation or combination: type; nature of product; package quantity; order quantity; volume of package or material; weather or temperature of a location of the user; a geography or location of the user; durability of a product; a recommended daily dosage; nutritional or caloric content of product; season or time of the year; industry recommended obsolescence time; warranty coverage; time of day; holiday schedule; category trends; usage patterns; frequency of orders; date; product category; and/or accepted product lifespan. A list of potential recurring transactions or products based on the determined recurring frequency is identified. The generated list of potential recurring transactions or products with information of the identified one or more retailers in the user account is consolidated. The method further processes one or more recurring transactions or products from the consolidated list in response to a request.

### BRIEF DESCRIPTION OF DRAWINGS

FIG. 1 is a diagram illustrating an example of a computing system according to one embodiment of the invention.

FIG. 2 is a diagram illustrating a system for processing recurring transactions according to one embodiment of the invention.

FIG. 3 is a flowchart illustrating interactions between a user and a system for saving items for purchasing according to one embodiment of the invention.

FIG. 4 is a flowchart illustrating interactions between a user and a merchant website embodying a system for processing recurring transactions according to one embodiment of the invention.

FIGS. 5-9 are screenshots illustrating processing an exemplary recurring transaction on a website embodying a system according to one embodiment of the invention.

FIG. 10 is a flowchart illustrating interactions between a user and a mobile implementation of a part of a system for processing recurring transactions according to one embodiment of the invention.

FIGS. 11-16 are screenshots illustrating processing an exemplary recurring transaction on a mobile implementation embodying a system according to one embodiment of the invention.

Corresponding reference characters indicate corresponding parts throughout the drawings.

### DETAILED DESCRIPTIONS

Everyone needs recurring items, and embodiments of the invention create an easy yet efficient way to enable consumers or users (hereinafter collectively referred to as “users”) to create transactions for items on a recurring basis. It is more than knowing what a user wants; it is about the timing for the user in order to make the transaction process simple and intuitive. It is also about creating a new recurring transaction easier and more efficient.

Aspects of the invention also improve on previous “reorder” or “reship” routines, because “reorders” or “reshipments” on other systems merely involve a sequential redirection of the normal shopping or shipping process. The redirection occurs because the desired recurring item is already stored in a repetitive procedure. Unlike other systems, the invention allows the user (not the retailer) to trigger the purchase or reordering when the timing of it is not predictable according to a biological or physical clock, such as ordering feminine products based on a menstrual cycle.

In addition, embodiments of the invention build on heuristics to determine a non-intrusive and non-adversarial way to either suggest or facilitate the reorder or order of products they trust and use on a regular or irregular basis. For trusted products and brands, users may not always have the time or inclination to re-shop for a lower price or extraordinary deal. For some users, it may be enough and an acceptable value to simply reorder quickly.

For example, recurring items in the present disclosure are referred to, including products that are ordered more than once by the same user. Examples include, but are not limited to: contact lenses; perishables; apparel; vitamins and supplements; postage stamps; replaceable filters for water and furnace; light-bulbs; and batteries. Appendix A provides a non-exhaustive list of products that may also be considered as recurring items. It is to be understood that other items may be included without limiting or departing from the spirit and scope of the invention.

These recurring items may be consumed within a predictable interval, but the consumption does not necessarily need to predicate on timing. For example, suppose a user has ordered a six-month supply of coffee for user on a regular basis. However, because the user's parents are in-town for six months, the user's usual six-month supply of coffee may be consumed within 3 months. This means the user may wish to quickly order the same supply again before the user's typical six-month purchase of the same supply. At the same time, the user also may not want the merchant to send the user reorder reminders every three months because of this out-of-the-ordinary life event.

Aspects of the invention may generally be implemented in a computing device as depicted in FIG. 1 and described below. For example, parts of embodiments of the invention may be executed on a server (computer) end or a client (computer) in accordance with the description above. In another example, the client end may be on a portable computing device with a wireless communication capability. In this example, portions of embodiments of the invention may be implemented on the portable computing device. In another example, the client may transmit a portion of the commands or actions to be processed by a remote processing unit and/or stored by a remote memory, which may be part of a server located remotely from the client.

FIG. 1 shows one example of a general purpose computing device in the form of a computing device 100. In one embodiment of the invention, the computing device 100 may be a computer. The computing device 100 may include one or more processors or processor units 102. For example, the processor 102 may be of a single core processor or a multi-core processor. In another embodiment, the processor 102 may be a 32-bit processor, a 64-bit processor, micro-processor, quantum processor, or other types of processor. In one embodiment, the processor 102 further incorporates software capabilities hard-coded to the processor 102. As a further embodiment, an application programming interface (API) may be used as a processor 102 in certain implementations.

The computing device 100 also includes a system memory (hereinafter simplified and collectively as “memory”) 104. The memory 104 may include a bus 108 or internal communication system coupled to various system components including the memory 104 to the processor 102. There are many types of bus known in the art, such as one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The memory 104 includes at least some form of computer readable media. Computer readable media, which include both volatile and nonvolatile media, removable and non-removable media, may be any available medium that may be accessed by computing device 100. By way of example and not limitation, computer readable media include computer storage media. Computer storage media include volatile and nonvolatile, removable and non-removable media for storage of information such as computer readable instructions, data structures, program modules, or other data. For example, computer storage media include RAM, ROM, EEPROM, flash memory or other memory technology, optical disk storage (such as CD, DVD, or Blue-ray), magnetic cassettes, magnetic tape, magnetic disk storage, or any other tangible medium that may be used to store the desired information. Those skilled in the art would appreciate that data stored in the computer readable medium may be transmitted via modulated data signal, encoded signal, wired media, such as a wired network or direct-wired connection, or other wireless media, such as acoustic, RF, infrared, and Bluetooth®. Combinations of any of the above are also included within the scope of computer readable media.

In another example, the memory 104 includes computer storage media in the form of removable and/or non-removable, volatile and/or nonvolatile memory storing computer-executable instructions, such as an operating system, application programs or (app in certain mobile execution environment), other program modules, and program data. The memory 104 also stores user data, UI data, or a combination of above.

A user 114 may enter commands and information into the computing device 100 through one or more user interface input sources (hereinafter UI sources) 106. For example, a UI source 106-1 may be a touch-based user interface (such as a keyboard, a pointing device (e.g., a mouse, trackball, pen, or touch pad), or a touch screen), a UI source 106-2 may be a voice-based user interface, or a UI source 106-3 may be another user interface. For example, the UI source 106-3 may be a fingerprint scanner, a retina scanner, or a moisture analyzer. It is to be understood that other input devices (not shown) may include a joystick, game pad, satellite dish, a camera, or the like. These and other input devices are connected to the processor 102 through the UI source 106 that is coupled to the bus 108, but may be connected by other interface and bus structures, such as a parallel port, game port, or a Universal Serial Bus (USB).

In one embodiment, the UI source 106 may include a network interface, such as a network interface 110. For example, the network interface 110 may be a Wi-Fi chipset or a GPS chipset that provides location-based information.

The computing device 100 also includes a display 112 or other type of display device, such as a monitor, is also connected to the system bus 108 via an interface, such as a video interface. In addition to the display 112, computers often include other peripheral output devices (not shown) such as a printer and speakers, which may be connected through an output peripheral interface (not shown).

The computing device 100 may operate in a networked environment using logical connections to one or more remote computers or devices, such as a remote memory 116 or a remote processing unit 118. The remote memory 116 and/or the remote processing unit 118 may be housed in one unit as a remote computer (such as a personal computer, a server, a router, a network PC, a peer device or other common network node, and typically includes many or all of the elements described above relative to computing device 100). In another embodiment, the remote memory 116 or the remote processing unit 118 may be located at different locations remote from the computing device 100. For the example, the remote memory 116 may be a cloud storage space for storing frequently used commands or actions or characteristics of user commands or actions. The remote processing unit 118 may be a cloud-based processor or processing unit for assisting the processing of data transmitted from the computing device 100.

The network interface 110 includes a local area network (LAN) and a wide area network (WAN), but may also include other networks. LAN and/or WAN may be a wired network, a wireless network, a combination thereof, and so on. Such networking environments are commonplace in offices, enterprise-wide computer networks, intranets, and global computer networks (e.g., the Internet).

When used in a local area networking environment, computing device 100 is connected to the LAN through the network interface 110. When used in a wide area networking environment, computing device 100 typically includes a modem or other means for establishing communications over the WAN, such as the Internet. The modem (not shown), which may be internal or external, is connected to the system bus 108 via the UI source 106, or other appropriate mechanism(s). In a networked environment, program modules depicted relative to computing device 100, or portions thereof, may be stored in a remote memory storage device (such as the remote memory 116).

For purposes of illustration, programs and other executable program components, such as the operating system, are illustrated herein as discrete blocks. It is recognized, however, that such programs and components reside at various times in different storage components of the computer, and are executed by the data processor(s) of the computer.

Embodiments of the invention may be described in the general context of computer-executable instructions, such as program modules, executed by one or more computers or other devices. Program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network, such as the remote memory 116 and the remote processing unit 118. As such, the processor 102 and the remote processing unit 118 may be in combination processing or executing the combined action. In another embodiment, the remote processing unit 118 may act as a backup to the processor 102 for processing the combined action. In a distributed computing environment, program modules may be located in both local (memory 104) and remote (memory 116) storage(s).

Generally, the data processors of computing device 100 are programmed by means of instructions stored at different times in the various computer-readable storage media of the computer. Programs and operating systems are typically distributed, and from there, they are installed or loaded into the memory 104 of the computing device 100. At execution, they are loaded at least partially into the computer's primary electronic memory.

The UI sources described herein may all be part of a single interface or may be implemented as separate interfaces or any combination therein. The interfaces may execute locally or remotely to provide functionality. Further, the interfaces may include additional or less functionality than illustrated or described herein.

Referring now to FIG. 2, an overview of a system 200 for processing recurring transactions. For example, the system 200 includes a processor 212 for processing recurring transactions and a data store 202 for storing data needed to process recurring transactions. In one example, the processor 212 may be a processor or a collection of processor either in one or more physical locations. In one example, the data store 202 may be a memory (such as the memory 104), a database or a plurality of databases. The data store 202 may further be connected with one or more back-end servers for facilitating the storage and processing of the data for storage in the data store 202. In one embodiment, the data store 202 and the processor 212 are at a second site. The data store 202 is also connected via the Internet or other computer network connections to one or more first sites or merchant shopping sites 204, such as a merchant shopping site 204-1, a merchant shopping site 204-2, and a merchant shopping site 204-3.

The first site and the second site are different location-wise. For example, each of the merchant shopping sites 204 may be operated by an independent merchant that manages the site, the product web pages, the organization of the website and the underlying data organization/storage for the site 204. In one example, the merchant shopping site 204 may be an online store having a plurality of web pages for processing purchase transactions of products carried by the merchant. In another example, the merchant shopping site 204 may be an online store having a plurality of web pages for processing purchase transactions of products carried by a plurality of merchants. In a further example, the merchant shopping site 204 may be an online search result page in which a user 206 may be redirected to other sites to finalize the purchase. In an alternative example, the merchant shopping site 204 may be a physical storefront, check-out register, or check-out counter in which the user 206 may take any purchasing item physically to conduct the check-out process. In this example, aspects of the invention will facilitate and prepare for a recurring transaction at the merchant shopping site 204 so that it is more convenient to complete the recurring transaction when the user 206 needs the product (described in further detail below). In yet another example, the merchant shopping site 204 may be a product listing or catalog included in an email message, an ad banner redirect shown in a web page, paid online advertising, scannable QR codes, or a product listing or catalog within a mobile app.

Referring again to FIG. 2, the system 200 also includes a consolidated shopping cart 208. For example, the system 200 enables the user 206 to transfer the ordering of individual products into one online area independent of the retailers' checkout process. In this process, the user 206 may bring products from various retailers under one cart's management. This is of course different from existing practices where each retailer or merchant maintains its own shopping cart for the user 206. This is also different and distinguishable over an uber-store or a “department-store” type of merchants in which different brands and products are available to the user 206. For example, most cart systems are built on different and proprietary technologies, they are not designed to interact or communicate with other cart systems. This leaves the user 206 at a disadvantage, unable to batch products from across their favorite stores. The user 206 needs to complete multiple checkout routines, remember multiple passwords, and trust their credit information with multiple retailers. Embodiments of the invention enable the user 206 to consolidate or unite products ordered from multiple stores into one convenient storefront or shopping cart. In one embodiment, the storefront or shopping cart may be presented with a user interface and/or a mobile application installed on an interfacing device 210 of the user 206.

In one example, the interfacing device 210 may be a smartphone, a wearable device, a mobile phone, a tablet, a computer, television, gaming console, automobile or other device(s) that is/are capable of connecting to the Internet or computer networks. In another example, the interfacing device 210 may be a smartphone, a wearable device, a mobile phone, a tablet, a computer, television, gaming console, automobile or other device(s) that is/are capable of connecting to another computing device wirelessly such that the other computing device(s) may transmit data to the interfacing device 210. In yet another example, the interfacing device 210 may have the capability of installing and running an application or program stored thereon. In this example, the application installed thereon may incorporate parts or all of the features or aspects of the invention. In the example where the application is not installed or stored on the interfacing device 210, aspects of the invention may provide a webpage or a cloud based service to the interfacing device 210. In another example, the interfacing device 210 is at a third site. The third site is different from the first site or the second site.

Referring to FIG. 3, a flowchart illustrates interactions between a user and a system for making items for purchasing according to one embodiment of the invention. In this embodiment, the user may likely be a merchant, a retailer, or other product providers hosting a website, a web page, or an online market place portal. As such, the user may begin from 302 that initiates a configuration process with the system embodying aspects of the invention, such as the system 200, by setting up an account or a new registration. It is to be understood that this process will likely be used by a new registration and does not need to be repeated for repeat users. The user starts at 304 with a sign up button to register with the system. The user next proceeds to 306 to complete the registration. In one embodiment, 306 includes a registration through a secure form to be completed by the user. In another embodiment, 306 may be completed through other secure means, such as electronic data interchange (EDI) or other automated fashion. In the example shown in FIG. 3, 306 includes entering at least one of the following information:

Name of the business, contact name, email address, or phone;

Payment gateway, authorize.net, transaction key, and API login ID for the user;

A list of re-orderable stock keeping unit (SKU) numbers, product names, a reorder cost, shipping cost for each of such re-orderable SKUs, and any tax to be generated depending on states; and

Credit card information detail, business address, terms of service agreement, and other payment related information.

In one embodiment, the user may progress to 308 to opt-in for subsequent communications, such as update notices, service updates, or other notices, etc. At 310, the user will finalize a credit card authorization. In the event that the user does not wish to opt-in or after the credit card authorization is completed, the user is taken to 312 to have its registration or account connected or coupled with a database via an API. For example, the API may connect to the database to create a new account, denote credit card authorization status. Similarly, the database may begin to set up storage structure for the information transmitted via the API, such as merchant information, product information, and payment information.

At 316, the registration or account set-up is approved. If the approval is not successful, the user is taken to 320 to complete or supplement any additional information or request by the system. At 318, in one example, a welcome email is dispatched to the user to verify a successful setup. At 322, the user may then access the established account or dashboard showing settings and options to configure the account.

In operation, for example, the merchant would enter name and contact information, such as address, phone and email address. The merchant would next enter payment information and establish accounting information and an API login ID is assigned to the merchant once this process is completed. Thirdly, the merchant may list items' SKUs and names and other product related information including but not limited to pricing and product images. The merchant would also enter or import the cost of reordering each unit, the shipping cost, and other cost information, such as sales tax information. Next, the merchant would finalize the sign-up process by entering merchant information as well as signing the service agreement.

Upon activation of the retailer's account, the merchant may return to manage the account by logging-in to a merchant dashboard/management console to add more products' SKUs, etc. It is to be understood that with the use of the API, much of the update process after the initial sign-up may be automated at a given interval or triggered by the merchant's manual control. It is also to be understood that, while the above process describes a typical sign-up process, other steps may be added, or steps may be modified without departing from the spirit and scope of the invention.

In another embodiment, the API employed in the above illustration in FIG. 3 may include one or more additional functionalities, such as connecting to a database, monitoring or “listening” for database changes, create account (types: merchant—verified (paying), merchant—unverified, user—test, user—full), modify account type and settings, add/delete products (merchants and users), get product by merchant (for single user, merchant, all), get recurring orders (merchant dashboard and user dashboard/history). Moreover, it is understood that aspects of the invention may further include features such as one or more of the following for the API: ability to include additional payment gateways; .csv upload of products; auto-generated credit card reminders; user admin (for web version); searchable directory in mobile implementation; and types of companies/products (for sorting and searching).

FIG. 4 is a flowchart illustrating interactions between a customer and a merchant website embodying a system for processing recurring transactions according to one embodiment of the invention. In this embodiment, a merchant would first establish an account according to FIG. 3 above. In addition, in conjunction with discussing FIG. 4, FIGS. 5-10 are screenshots showing exemplary rendering of the steps discussed in FIG. 4. Once the merchant has an activated account for the services provided by the system, at 402, (also illustrated in FIG. 5, a screenshot 500 showing the successful logged in state) the system may provide a script to be inserted in one of the merchant shopping sites 204. For example, the script may be in the form of Javascript inserted into a web page of the merchant shopping sites 204. An example of such code is provided below for illustration purpose only and not as a limitation:

```
FOOTER SCRIPT CODE START
<script type=“text/javascript”>
  var gatr_config = {
    merchant_id: ‘exampleretailer’,
    site_id: ‘exampleretailer.com’,
    button_style: ‘small’
  };
  (function( ) {
    var gatr_widget = document.createElement(‘script’);
    gatr_widget.type = ‘texthavascript’;
    gatr_widget.async = true;
    gatr_widget.src = ‘http://assets.gimmestaging.com/button/button.js’;
    var gatr_node = document.getElementsByTagName(‘script’)[0];
    gatr_node.parentNode.insertBefore(gatr_widget, gatr_node);
  }( ));
</script>
FOOTER SCRIPT CODE END
BUTTON CODE START
<div class=“gimmeanother-button” data-gimmeanother-sku=“SKU”></
div>
BUTTON CODE END
```

It is to be understood that other programming language script may be used without departing from the spirit and the scope of the invention. In another embodiment, the script may be stored in a storage embedded in a chip or programmed. For example, if the merchant shopping sites 204 is a cash register, the script maybe included as part of the memory of the cash register device. In such a situation, any updates to the script may be transmitted either wirelessly or wired, depending on the type and capability of the device.

In one embodiment, the script would be inserted on the retailer website, along with a keycode or unique identifier to verify the account, allowing aspects of the invention to use technology to scan the entire HTML content, programmatically searching for instances of a unique product identifier or SKU as provided by the retailer. Where no SKU or unique identifier has been provided, the script will look for tell-tale signs of SKUs or unique identifiers including field names, including, but not limited to, “productID” and “SKU.”

In another embodiment, the script would scan through any website page featuring retail or wholesale products for sale and tag each product as to allow for addition of a product to queue stored in off-site database. Using either input from retailer or a series of rules to determine SKUs within the page, the script will allow any designated product to be “saved” offline for future reference based entirely on the SKU or unique identifier and website URL. In one embodiment, the script may also save designated product in an online or connected status. The script will also allow retailers to set different prices in a third-party location available to customers.

In a further embodiment, the script may also provide or identify one or more of the following information:

(a) Updated Inventory/Stock Information (Fly in inventory information via XML or other technologies from distributors at SKU or unique product identifier level);

(b) Updated Pricing/Sale Information (Allow manufacturers to display Minimum Advertised Price (MAP) pricing confirmation or populate coupon or rebate savings next to specific products at SKU or unique product identifier level);

(c) Recall/Product Safety Announcements (Display and make easily accessible consumer safety and recall information next to specific products based on SKU or unique product identifier level); and/or

(d) Third-Party Reviews (Use SKUs or unique product identifiers to aggregate third-party product reviews to any website or online store).

As such, through the exemplary implementation of the script (as described above) as well as the API that consolidates product items from different merchants for storage in the database (see 312 in FIG. 3), aspects of the invention provide a unique implementation that provides an optimal shopping experience. The creation of a consolidated shopping cart, as discussed above in FIG. 2, enables a customer, such as the user 206, to quickly reorder items conveniently. By consolidating product SKUs from different merchants and placing them directly to the consolidated shopping cart, embodiments of the invention hide the complicated and sometimes repetitive payment/confirmation routines from the customer (as further illustrated in FIGS. 10-16). As such, the processor, such as the processor 212, may generates a set of products from the data store 202 based on the exemplary implementations above.

Referring to FIG. 4 again, at 404, a customer, such as the user 206, would either login to a previous established account embodying aspects of the invention (such as the system 200) or the customer would create a new account. In the event that the customer does not have an account, the customer is led to a set of setup/sign up routine at 406. In one example, the customer is asked to enter account setup information such as an email account. In one embodiment, the product SKU in which product the customer is interested is prefilled along with the customer's email address. The email address and the prefilled SKU is saved. An API next creates a temporary account for the customer and an email with the temporary account information is sent to the customer's email address for verification. Once the customer verifies the account, the API converts the temporary account to a full account and the customer is invited to install a mobile implementation (such as a mobile app on a mobile device) of the system 200. In the event the customer does not how to install or download the mobile implementation, an instructional page may be provided to facilitate such action.

Once the mobile implementation is installed on a mobile device of the customer or in the event that the customer already has an account with the system, at 408, the customer is notified that he or she is now logged in. Next, the customer can then save the desirable product for recurring transactions to the account of the customer via the API. In one example, as shown in FIG. 6, a screenshot 600 shows a trigger or a button 602 for the customer to save the desirable product for recurring transactions. It is to be understood that communications between the API and the database will occur to effect such action. The customer will again be notified that the item has been successfully added. In this example, FIG. 7 illustrates a screenshot 700 showing such a first notification, and FIG. 8 shows a screenshot 800 indicating a completion notification.

Moreover, the customer may receive a further confirmation email, such as a screenshot 900 in FIG. 9, and the customer is invited to use the mobile implementation to further complete the transaction (to be further discussed in FIG. 10).

FIG. 10 is a flowchart illustrating interactions between a user and a mobile implementation of a part of a system for processing recurring transactions according to one embodiment of the invention. Moreover, FIGS. 11-16 will be discussed in conjunction with FIG. 10 as they illustrates screenshots showing exemplary renderings of some of the steps illustrated in FIG. 10. For example, a customer, such as the user 206, downloads the mobile implementation at 1002 and opens the mobile implementation for the first time at 1004, as shown in a screenshot 1100 in FIG. 11. At 1006, the customer verifies whether he or she has an existing account with a system embodying aspects of the invention, such as the system 200. If the customer does not already have an account with the system, the customer is prompted to go through 1008 and 1010 to establish an account.

Once the account is established or the customer logins to the account at 1012 (maybe prompted at 1014 if login retrieval is needed), the customer is taken to 1018. It is to be understood that in the background, unbeknownst to the customer, an API and a database accessible by the system, will process and handle interactions between the mobile implementation and the system. At 1018, a listing of possible or previous recurring transactions in a consolidated shopping cart managed by the system is displayed or rendered to the customer. For example, FIG. 12 shows a screenshot 1200 illustrating such an example. The system 200 includes items or products from one or more different merchants in the consolidated shopping cart for convenient reordering. Unlike previous systems where the customer may need to go to different shopping carts at different merchant sites to reorder items, aspects of the invention enable the customer to reorder products conveniently and quickly via the mobile implementation.

In one embodiment, the system provides a sorting or reorganizing process to determine optimal reorder frequency for products while removing outliers, including but not limited to: quantity; volume; weather; season; industry recommended category obsolescence time; time of day; holidays; category trends within system; usage patterns; and, of course, frequency and/or normal product lifespan. Moreover, in another embodiment, calculation of best reorder time, suggested reorder time or frequency based on pattern and mean, not only average frequency.

In an alternative embodiment, one or more of the following criteria may also be considered for sorting or reorganizing the collected data, providing a recommendation to initiate a recurring transaction based on the identified recurring pattern: package quantity; order quantity; volume of package/material; weather/temperature; geography/location of consumer or user; durability; recommended daily dosage; nutritional/caloric content of food; season/time of year; industry recommended obsolescence time; warranty coverage; time of day; holiday schedule; category trends; usage patterns; frequency of orders; date; product category; and/or accepted product lifespan.

These criteria may be part of the sorting algorithm as parameters. In addition, a weighted mathematical value may be assigned to the parameters for further fine-tuning or customization. In one embodiment, the processing of the collected data generates a potential recurring transaction to be recommended to the customer in the consolidated shopping cart, as shown in FIG. 12.

Referring again to FIG. 10, at 1020, the customer may add an additional item to the consolidated shopping cart. In one example, FIG. 13 illustrates a screenshot 1300 that the customer wishes to reorder. In FIG. 14, a screenshots 1400 shows an exemplary dialogue box to the customer after the customer has reordered the desirable item at 1022. Once the customer selects “CONFIRM” button 1402 in FIG. 14, the customer's credit card would be charged according to merchant-specific payment gateway at 1024. However, the customer may not realize this as the system 200 performs this smoothly and effortlessly without asking the customer to be hassled with additional confirmation steps. Similarly, the system at 1026 triggers notifications for the API to note orders for merchant, the customer, etc., about the recurring transaction. Lastly, at 1028, the customer receives a confirmation that a recurring transaction has completed. For example, FIG. 15 shows a screenshot 1500 illustrating such confirmation.

FIG. 16 shows a screenshot 1600 illustrating an updated consolidated shopping cart after the customer completes the reordering according to FIG. 10. One would note in particular that the recurring transaction, marked 1602 in screenshot 1600 is shown as the first item. Comparing the screenshot 1600 to the screenshot 1200, the screenshot 1200 also shows a similar item 1202 of the same product. As such, aspects of the invention maintains a consolidated shopping cart of items so that the customers can quickly initiate and complete a recurring transaction. Moreover, while the illustrations in FIGS. 11-16 show that the desirable item is sold from the same merchant, aspects of the invention do not limit the customer's ability to purchase the same item from another merchant.

In operation, from the user 206's perspective, aspects of this invention may be implemented and practiced as below. The user 206 initiates the overall process by first visiting one or more merchant shopping sites 204 to start a transaction. Based on the script above, in addition to completing the purchase as intended, the user 206 may optionally mark one or more items in the purchase as a product to be placed on data store 202 to be purchased again in the future. In one embodiment, the user 206 may initiate the purchase via an email sent to the mailbox of the user 206 that contains links to initiate a transaction, similar what's illustrated in FIGS. 4-9.

User 206 can create an account at any one or more points, which include, without limitation or combination of points of account creation, the product page, the view cart page, the confirmation page and/or the receipt page at the merchant shopping site 204 to access the consolidated cart 208 that will keep all products that the user 206 has identified (e.g., user may save the product(s) at these pages).

In one embodiment, a temporary account is automatically created for the user 206 when user 206 initiates the save product function noted above, and an email message containing the temporary account information is sent to the email address of the user 206 when the user 206 completes the save product function. This feature is advantageous to the user 206 because it allows a product to be saved to data store 202 prior to creation of an email-confirmed account. The save to mobile function allows the user to save a product or products accessible via a consolidated cart on a mobile device.

The user 206 may also download and install or otherwise access an application to the interfacing device 210 of the user 206 for convenient access to the consolidated cart 208. The consolidated cart 208 will store a queue of products that the user 206 has identified throughout the user 206's shopping experiences elsewhere on one or more merchant shopping sites 204. When the user 206 wishes to begin a recurring transaction, the user 206 can easily interact with the application on the interfacing device 210 without the need to log into the merchant shopping sites 204 to complete the transaction. The process will result in significant time saving to user 206 in subsequent transactions of saved products because the subsequent recurring transaction(s) does not require full interaction with the merchant shopping sites 204-1, 204-2, 204-3 or their existing checkout processes.

In another embodiment, the application on the interfacing device 210 may provide a notification to the user 206 based on the sorting processing described above to suggest or recommend a potential recurring transaction. If the user 206 agrees to complete the potential recurring transaction, the user 206 can simply interact with the application to complete the recurring transaction rather than interacting with the merchant site(s) 204.

As to completing a recurring transaction, the retailer will define the stock level and price (with shipping and tax stated separately) of the product via the data store 202. The user 206 will then have the opportunity to approve or decline the shipment of product(s) and charge to the consumer's credit card or associated online payment account.

In this embodiment, after a consumer confirms the order or recurring transaction, the corresponding merchants are alerted of the new incoming orders via email, social media, or by logging into the merchant dashboard/management control. Order total is processed via the retailer's online gateway, and the user 206 will receive the order confirmation as usual.

As a result of each of the embodiments of the invention discussed above, together or alone, reordering will no longer be a burdensome process.

In the event that a particular merchant shopping site 204 is not part of the system 200, the user 206 may tag the page and product ID to the account of the user 206 associated with the system 200. The user 206 can then easily return to that page to shop for the same product again while also leaving a marker for the retailer indicating consumer willingness to reorder this product via the application. Popular products may have many SKU-Tag markers associated with the system 200 on a single product indicating strong consumer sentiment to reorder a product quickly and easily.

Alternatively, in the event that a particular merchant shopping site 204 is not part of the system 200, the user 206 may save the SKU-Tag of the item to the account of the user 206 associated with the system 200. Additional data points related to the item may also be saved as part of this action by user 206. The user 206 may then request a reorder of this product via system 200.

In an alternative embodiment, rather than waiting for the user 206 to discover products on the merchant shopping sites 204, the user 206 may also find/add products to a queue of the consolidated cart 208. Moreover, the system 200 may further combine the use of reminder messages to the user 206 to initiate a potential recurring transaction.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In operation, computing device 100 executes computer-executable instructions such as those illustrated in the figures to implement aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements or aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope or aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

A non-exhaustive list of possible items/products:

Adhesive/Glue/Super Glue

Writing Instruments and Supplies: Chalk/Packs of Sharpies/Pens/Pencils/Refills

Baking Supplies: Aluminum Foil/Ziplock Bags/Parchment Paper/Cellophane

Kitchen Supplies: Dishwasher Soap/Hand Soap/Deodorizers/De-Greasers

Over-the-counter Medicine: Aspirin/Ibuprofen/Allergy Medicine/Cold Medicine

Prescription Medicines/Pharmaceuticals

Packing Supplies: Boxes/peanuts/strap tape

Filters: Air/Water/Furnace/Pool

Pool Supplies

Parking Stickers/Permits

Apparel: Jeans, Socks, Shoes, Undershirts, Underwear

Cosmetics: Perfume/Lipstick/Eye Shadow/Blush

Bathroom/Toiletries: Toothpaste/Floss/Deodorant

Hair Supplies: Combs/Brushes/Hair Spray/Gel/Shampoo/Conditioner/Dye

Art Supplies: Paints/brushes/portfolios

Pet Supplies: Pet Food/Pet Medicine/Treats/Litter/Toys

Baby Supplies: Diapers/Formula/Accessories/Powder/Lotion/Wipes

Batteries

Phone Calls/Phone calling credit/Top-ups

Bedding

Food/Beverages: Pizza/Steaks/Produce/Wine/Beer

Bicycle Supplies: Tires/Tubes/Grease/Chamois Cream/Sun Protection

Copy/Printer Supplies: Ink/Cartridges/Toner/Canned Air/Paper/Printer Drums

Canning Supplies

Auto Supplies: Belts/Oil/Windshield Washer/Windshield Wipers/Filters (air/oil)

Propane/Gas

Recharge Accounts (i-pass, code canyon, etc.)

CD-ROM/Blank Compact Discs

Cellphone/Mobile Device Chargers & Cords

Key replacements

Checkbooks/Replacement Checks

Office Supplies: Stationary/Scotch Tape/Staples, Post-Its®/Envelopes/Paper Clips

City Parking Stickers

Seamless Rolls for photography

Cloud-based Storage Space

Shoe Supplies: Shoelaces/Shoe Shine

Coffee & Coffee Filters

Contact Lenses/Contact Lenses Rinse or Wash

Sports Drinks

General Sports Gels

Sports Nutrition

Disposable Utensils/Plates/Cups

Stamps/Postage: book/roll/individual/prepaid priority envelopes

Music Supplies: Drum Sticks/Drum Heads/Strings/Oil/Picks

Energy Bars/Nutrition Bars

Feminine Products: Tampons/Pads/Douche/Pregnancy Tests/Condoms

Personal Pleasure Items: Message Oils/Sex Toys/Lubrication

Laundry Supplies: Detergent/Softener/Bleach/Stain Remover

Take-Out-Food

Tickets: Theatre/Movie/Sports Events

Weather Related Items: Umbrellas/Gloves/Hand Warmers

Cleaning Supplies: Vacuum Bags and Belts/Toilet Cleaner/Disinfectants/Rags

Personal Health: Hand Lotion/Lip Balm/Sun Tan Lotion

Health/Fitness Related Items: Weight Gain/Loss Supplements/Vitamins

Drinking Water: Bottles/Coolers/Jugs/Canisters

Light Bulbs

WD-40/Lubricants

Subscriptions: Magazine/Paper/Clubs/Memberships

Memory Cards, Flash Memory, USB Memory Drives, External Hard Drives

Wrapping Paper/Bows/Ribbons

Craft Supplies

Building Supplies

What is claimed is:

1. A method for identifying recurring transactions comprising:
reviewing a record of purchases of a user, said record comprising purchases from one or more retailers;
storing said reviewed record in an account for the user, said reviewed record comprising one or more of the following: order details and product details;
identifying a recurring pattern of purchases from the stored record based on one or more of the following factors, among others: type; nature of product; package quantity; order quantity; volume of package or material; weather or temperature of a location of the user; a geography or location of the user; durability of a product; a recommended daily dosage; nutritional or caloric content of product; season or time of the year; industry recommended obsolescence time; warranty coverage; time of day; holiday schedule; category trends; usage patterns; frequency of orders; date; product category; and accepted product lifespan;
providing a recommendation to initiate a recurring transaction based on the identified recurring pattern; and
receiving a confirmation to the provided recommendation.

2. The method according to claim 1, wherein receiving the confirmation comprises receiving a purchase order of the product with a quantity according to the provided recommendation.

3. The method according to claim 1, wherein receiving the historical record comprises receiving a reorder reminder from one or more retailers or the interface provider(s).

4. The method according to claim 1, further comprising sorting the recurring pattern.

5. The method according to claim 1, wherein providing said recommendation comprises predicting a reorder frequency of a purchase based on the record.

6. The method according to claim 1, further comprising establishing an account for the user in response to receiving information including one or more of the following: account identifying information, additional personal information, shipping information, and payment information from the user.

7. The method according to claim 6, wherein establishing the account comprising establishing the account in response to installing a program on a mobile device of the user.

8. A system for facilitating recurring transactions comprising:
a first database at a first site for storing product information;
a computer network connection;
a processor, at the second site, configured to execute computer-executable instructions for:
generating a set of products from the first database;
establishing an account for recurring transactions in response to a request received through said computer network connection, said account for recurring transactions identifying one or more products from the set of products from the first database;
providing one or more recurring transactions in a list based on the identified one or more products in the account; and
upon receiving a transaction request via the computer network connection, facilitating a completion for a recurring transaction from the provided list of recurring transactions,
wherein the first database stores information associated with the account.

9. The system according to claim 8, wherein said processor is configured to execute computer-executable instructions for facilitating comprises transmitting information associated with the transaction request and the recurring transaction to a processor and the first database at the first site.

10. The system according to claim 8, wherein the processor is further configured to execute computer-executable instructions for generating temporary account information in response to receiving the request and before the account is established.

11. The system according to claim 8, wherein the first database stores the temporary account information.

12. The system according to claim 8, wherein the processor is further configured to execute computer-executable instructions for generating a period before the processor provides one or more recurring transactions in the list.

13. The system according to claim 8, wherein the processor generates the set of products comprises:
transmitting a set of computer-executable instructions to the first database at the first site via the computer network connection, wherein said transmitted set of computer-executable instructions identifies the product information at the first database; and
receiving the identified product information from the first database to the first database via the computer network connection.

14. The system according to claim 8, wherein the processor is configured to execute computer-executable instructions for facilitating the completion of the recurring transaction from the provided list of recurring transactions upon receiving a transaction request from a third site via the computer network connection.

15. A method for processing recurring transactions comprising:
identifying one or more retailers from a list of potential transactions;
collecting ordering information from the one or more identified retailers;
determining a recurring frequency based one or more factors, which include, without limitation or combination of factors, of a transaction: type; nature of product; package quantity; order quantity; volume of package or material; weather or temperature of a location of the user; a geography or location of the user; durability of a product; a recommended daily dosage; nutritional or caloric content of product; season or time of the year; industry recommended obsolescence time; warranty coverage; time of day; holiday schedule; category trends; usage patterns; frequency of orders; date; product category; and accepted product lifespan;
generating a list of potential recurring transactions based on the determined recurring frequency;
establishing a user account;
consolidating the generated list of potential recurring transactions with information of the identified one or more retailers in the user account; and
processing one or more recurring transactions from the consolidated list in response to a request.

16. The method according to claim 15, wherein the identifying of one or more retailers from the list of potential transaction(s) is comprised of identifying one or more retailers from the list of potential transactions in response to establishing a retailer account for each of the one or more retailers.

17. The method according to claim 15, wherein the processing comprises:
receiving a request from a user to complete the one or more recurring transactions;
transmitting the request and information of the user to the one or more retailers; and
receiving a confirmation from the one or more retailers in response to a completing of the one or more recurring transactions.

18. The method according to claim 17, further comprising receiving inventory information from the one or more retailers in response to the transmitting.

19. The method according to claim 15, further comprising establishing a temporary account in response to the list of potential transactions.

20. The method according to claim 15, further comprising requesting a user to establish the user account in response to the generation.
